(19) United States
(12) Patent Application Publication
(10) Pub. No.: US 2026/0149344 A1
(43) Pub. Date: May 28, 2026

(54) MANUFACTURING ASSEMBLY AND METHOD OF MAKING LAMINATED CORES

(71) Applicant: METAL INDUSTRIES RESEARCH AND DEVELOPMENT CENTRE, Kaohsiung (TW)

(72) Inventors: Wan-Chi CHANG, Kaohsiung (TW); Chih-Ping HSU, Kaohsiung City (TW); Chien-Sheng HUANG, Kaohsiung (TW)

(21) Appl. No.: 19/271,237

(22) Filed: Jul. 16, 2025

(30) Foreign Application Priority Data
Nov. 28, 2024 (TW) 113146112

(51) Int. Cl. H02K 15/0273; H02K 15/027; H02K 15/0278

(52) U.S. Cl. CPC H02K 15/0273; H02K 15/027; H02K 15/0278; H02K 2215/00

(57) ABSTRACT

A manufacturing assembly adapted for making a laminated core composed of stacked metal plate bodies includes a stacking mold, a pre-fixing device, and a receiving device. The stacking mold includes a stacking space extending though the stacking mold adapted for the metal plate bodies to be fed into so that the metal plate bodies are stacked. The pre-fixing device includes two laser welding machines that are disposed around the stacking space at two angularly spaced apart positions and that sequentially welds each metal plate body to an adjacent metal plate body to form the laminated core. The receiving device receives the laminated core and is controllable to discharge the laminated core. A method of making laminated cores is also included.

### CROSS-REFERENCE TO RELATED APPLICATION

This application claims priority to Taiwanese Invention Patent Application No. 113146112, filed on Nov. 28, 2024, the entire disclosure of which is incorporated by reference herein.

### FIELD

The disclosure relates to a manufacturing assembly, and more particularly to a manufacturing assembly adapted for making a laminated core and a method of making laminated cores.

### BACKGROUND

Due to increasing environmental awareness, achieving carbon neutrality has become a trending issue. This has led to increasing efforts in the development of electric vehicles by major car manufacturers. A major concern in the development of electric vehicles is finding ways to increasing the range of the electric vehicle. Therefore, the electric motors used in electric vehicles have increasingly become smaller in size, become more powerful, and are able to operate at higher revolutions per minute. Major car manufacturers are working to decrease core loss (currently at 20% to 30%), and decreasing electromagnetic steel sheet thickness to increase cumulative stacking rate. A conventional laminated iron core has a plurality of stacked electromagnetic steel sheets that may be riveted, welded together, or adhesively formed together. Since riveting or welding may cause the magnetic channel in the iron core to be more constricted, and reduce the magnetic flux density of the iron core, adhesive-type iron cores have become the main type of iron core used by large international manufacturers. Electric vehicles using adhesive-iron core electric motors may see electric motor strength gains of 50 times and 20% less core loss over that of other types of iron cores. Additionally, such electric motors may operate with 10 dB lower noise and may see a high efficiency zone increase from 3% to 18%, thereby achieving a higher power density. However, in order to achieve adhesion between steel sheets to form a laminated core during manufacture, the surfaces of the steel sheets need to be covered by an adhesive glue which is heat activated. Afterwards, the steel sheets are stacked in a stacking mold and heated so as to activate the adhesives. This requires the conventional production equipment to have heating elements installed in the stacking mold which complicates their structure and reduces their reliability. Additionally due to the above reasons, conventional production equipment is also expensive and costly.

### SUMMARY

Therefore, an object of the disclosure is to provide a manufacturing assembly for making laminated cores and a method of making laminated cores that can alleviate at least one of the drawbacks of the prior art.

According to one aspect of the disclosure, the manufacturing assembly is adapted for making a laminated core from a plurality of metal plate bodies, each of which has a plate body portion that has an upper adhesive section and a lower adhesive section respectively disposed on two opposite sides of the plate body portion. The manufacturing assembly includes a stacking mold, a pre-fixing device, and a receiving device. The stacking mold includes a stacking space that extends through a top surface and a bottom surface of the stacking mold. The stacking space of the stacking mold is adapted for the metal plate bodies to be sequentially fed downwardly into the stacking space from the top surface of the stacking mold, so that the metal plate bodies are stacked one above the other, and so that the upper adhesive section of the plate body portion of each of the metal plate bodies abuts a lower adhesive section of the plate body portion of an adjacent one of the metal plate bodies. The pre-fixing device includes at least two laser welding machines that are disposed around the stacking space at two angularly spaced apart positions and that each have a targeting end protruding into said stacking space to target each of the metal plate bodies which moves past the targeting end while moving downward inside the stacking space. The at least two laser welding machines sequentially welds each of the metal plate bodies to at least one of an upper adjacent one of the metal plate bodies and a lower adjacent one of the metal plate bodies to form the laminated core. The receiving device includes a carrier platform that is located below the stacking space, that is adapted to receive the laminated core descending downward from the stacking space, and that is controllable to flip and discharge outward the laminated core.

According to another aspect of the disclosure, the method of making laminated cores includes steps of: A) continuously advancing an unrolled portion of a metal sheet coil toward a die hole of a die of a stamping press via a conveyor device; B) repeatedly stamping the unrolled portion of the metal sheet coil into a plurality of metal plate bodies with a punch of the stamping press as the unrolled portion is continuously advanced to move over the die hole of the die so that the metal plate bodies sequentially fall downward into the die hole; C) causing the metal plate bodies to fall downward from the die hole into a stacking space of a stacking mold and to be stacked one above the other in the stacking space so that each of the metal plate bodies abuts an upper adjacent one of the metal plate and a lower adjacent one of the metal plate bodies D) performing a laser welding process in the stacking space to sequentially spot weld each of the metal plate bodies to at least one of the upper and lower adjacent ones of the metal plate bodies as the metal plate bodies descend downwardly in the stacking space, thereby forming the laminated core; and E) downwardly moving the laminated core from the stacking mold, and collecting and discharging outward the laminated core.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary schematic cross-sectional view illustrating an embodiment of a manufacturing assembly adapted for making a laminated core according to the present disclosure.

FIG. 2 is an enlarged fragmentary schematic cross-sectional view illustrating the embodiment of the manufacturing assembly that is in a state where a stamping step is performed.

FIG. 3 is the same view as FIG. 2 but illustrating the embodiment of the manufacturing assembly in another state where a laser welding process is performed.

FIG. 4 is a view similar to FIG. 2 but illustrating the embodiment of the manufacturing assembly in still another state where the laminated core is moved downward from a stacking mold.

FIG. 5 is a view similar to FIG. 2 but illustrating the embodiment of the manufacturing assembly in still another state where a step of collecting the laminated core is performed.

FIG. 6 is a view similar to FIG. 5, but illustrating the embodiment of the manufacturing assembly in still another state where a step of discharging the laminated core is performed.

FIG. 7 is a schematic block diagram illustrating a method of making laminated cores according to the present disclosure that uses the embodiment of the manufacturing assembly according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

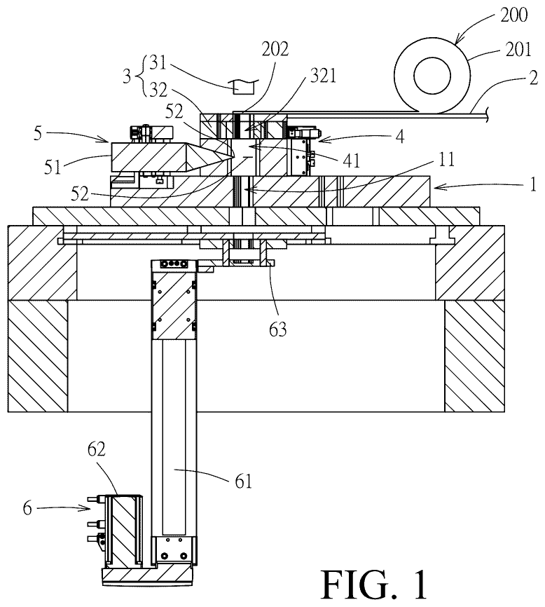

FIGS. 1 to 4 shows an embodiment of the present disclosure which is a manufacturing assembly adapted for making a laminated core 100. It should be noted herein that for clarity of description, spatially relative terms such as “front,” “back,” “top,” “left,” “right,” “bottom,” “upper,” “lower;” “on,” “above,” “over,” “downwardly,” “upwardly” and the like are used with reference to the position of the manufacturing assembly. In FIG. 1, the “front” is defined as the left of the manufacturing assembly in FIG. 1, the “back” is defined as the right of the manufacturing assembly in FIG. 1, the “upper” is defined as above the manufacturing assembly of FIG. 1, the “lower” is defined as below the manufacturing assembly of FIG. 1, the “left” is defined as facing the manufacturing assembly of FIG. 1, and the “right is defined as moving away from the manufacturing assembly of FIG. 1.

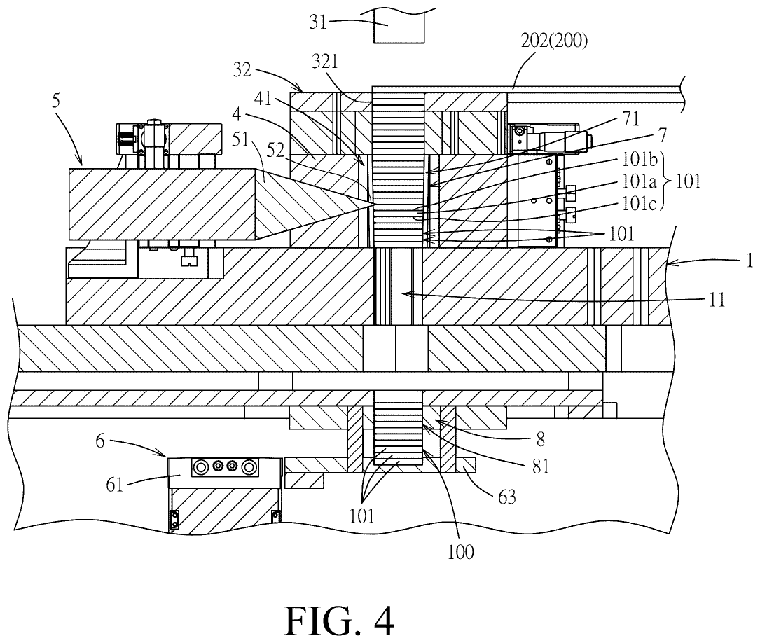

The manufacturing assembly is adapted for processing a metal sheet coil 200 for making the laminated core 100. The metal sheet coil 200 includes a rolled portion 201, and an unrolled portion 202 that is connected to the rolled portion 201 and that has been rolled out from the rolled portion 201. The metal sheet coil 200 may be a self-adhesive metal sheet coil where both the rolled portion 201 and the unrolled portion 202 has an adhesive layer (not shown in the Figures). The adhesive layer may be a heat-activated adhesive that requires heat upon application to form a strong adhesive bond. The laminated core 100 may be only a part of a motor stator laminated core or it may be the motor stator laminated core. Referring to FIG. 4, the laminated core 100 includes a plurality of metal plate bodies 101. Each metal plate body 101 has a plate body portion 101a that has an upper adhesive section 101b and a lower adhesive section 101c respectively disposed on two opposite sides of the plate body portion 101a. In this embodiment the metal plate bodies 101 are made from the metal sheet coil 200 via stamping. Therefore, the metal plate bodies 101 are made of the same material as the metal sheet coil 200.

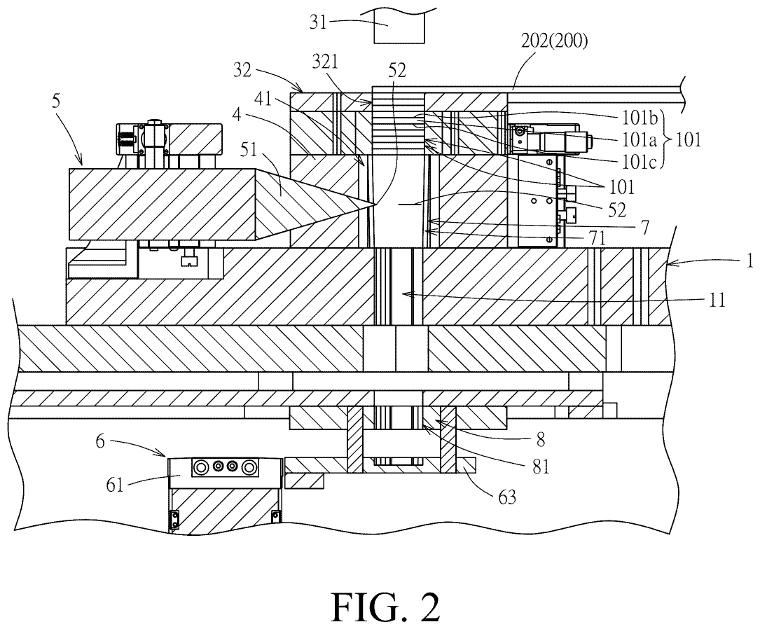

Referring to FIG. 2, the manufacturing assembly includes a base seat 1, a conveyor device 2, a stamping press 3, a stacking mold 4, a pre-fixing device 5, and a receiving device 6. The base seat 1 is disposed below the stacking mold 4 and includes a through hole 11 that extends through a top surface and a bottom surface of the base seat 1, and that is adapted for the laminated core 100 to pass through in a downward direction. The stacking mold 4 includes a stacking space 41. The conveyor device 2 may be, for example, a conveyor belt, and is disposed above the base seat 1. The unrolled portion 202 of the metal sheet coil 200 is laid flat on top of the conveyor device 2 which is adapted to continuously convey the unrolled portion 202 of the metal sheet coil 200 to advance forward.

Referring to FIGS. 1 and 2, the stamping press 3 is located downstream of the conveyor device 2 and above the stacking mold 4. The stamping press 3 includes a punch 31 and a die 32. More specifically, the punch 31 of the stamping press 3 is located above the base seat 1 and is located above and in front of the conveyor device 2. The die 32 is located above the base seat 1 and directly below the punch 31. The die 32 has a die hole 321 extending through a top surface and a bottom surface of the die 32, is aligned with the punch 31 and the stacking space 41, and aligned with the through hole 11 of the base seat 1. An opening of the die hole 321 has a shape that corresponds with a cross-sectional shape of the plate bodies 101. The top surface of the die 32 is located at a downstream side of the conveyor device 2 for holding the unrolled portion 202 of the metal sheet coil 200 that is conveyed by the conveyor device 2. Referring back to FIG. 2, the punch 31 is located above the top surface of the die 32 and adapted to repeatedly stamp the unrolled portion 202 of the metal sheet coil 200 to form the metal plate bodies 101, as the unrolled portion 202 is advanced by the conveyor device 2 to move over the die hole 321 so that the metal plate bodies 101 fall into the die hole 321 one after the other.

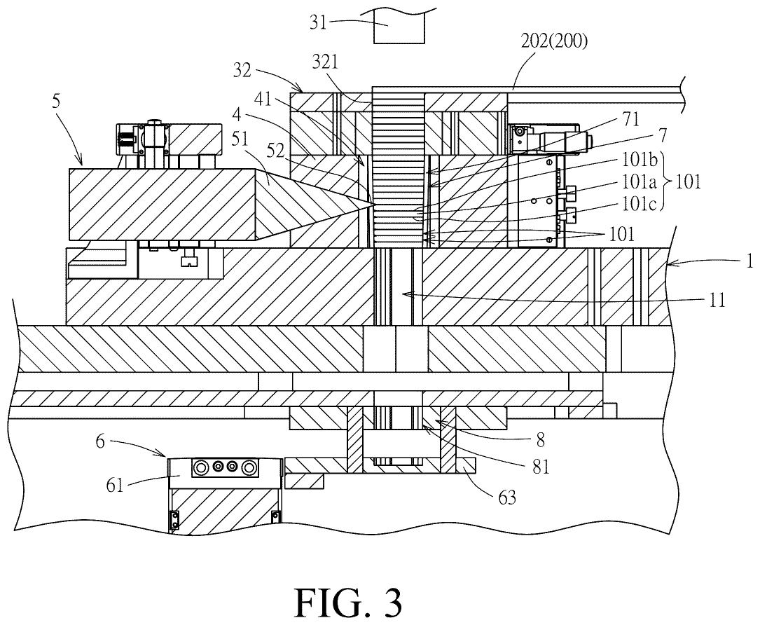

Referring to FIGS. 2 and 3, the stacking mold 4 is located between the die 32 and the base seat 1. The stacking space 41 of the stacking mold 4 extends through a top surface and a bottom surface of the stacking mold 4. The stacking space 41 is aligned with the through hole 11 of the base seat 1 and the die hole 321 of the die 32. The stacking space 41 of the stacking mold 4 is adapted for the metal plate bodies 101 in the die hole 321 to be sequentially and downwardly fed into the stacking space 41 from the top surface of the stacking mold 4, so that the metal plate bodies 101 are stacked one above the other and so that the upper adhesive section 101b of the plate body potion 101a of each of the metal plate bodies 101 abuts a lower adhesive portion 101b of the plate body portion 101a of an adjacent one of the metal plate bodies 101. In some embodiments, the manufacturing assembly includes a first squeeze tube 7 that is disposed in the stacking space 41 of the stacking mold 4. The first squeeze tube 7 includes a first squeeze hole 71 aligned with the die hole 321 and with the through hole 11 of the base seat 11. The first squeeze hole 71 is adapted for receiving the metal plate bodies 101 that are stacked one above the other, and has an upper opening with a diameter that is not greater than that of the die hole 321. Referring to FIG. 4, when the metal plate bodies 101 are sequentially and downwardly fed toward the stacking space 41 from the die hole 321, the metal plate bodies 101 sequentially fall into the first squeeze hole 71 of the first squeeze tube 7 that is disposed in the stacking space 41, and are stacked one above the other. The first squeeze tube 7 enables the metal plate bodies 101 to be stacked in a more neatly aligned and stacked fashion. This helps to improve the precision of the laminated cores 100 that are made by the manufacturing assembly of the present disclosure. In some embodiments, the first squeeze hole 71 of the first squeeze tube 7 progressively decreases in diameter from the upper opening in a downward direction. This may serve to restrict downward movement of the metal plate bodies 101 stacked within the first squeeze hole 71 when the metal plate bodies 101 in the first squeeze hole 71 are not subjected to any downward pushing force coming from a stamping action of the punch 31 which can push the metal plate bodies 101 to move from the die hole 321 to the first squeeze hole 71.

Referring to FIGS. 1 to 3, the pre-fixing device 5 includes at least two laser welding machines 51 that are disposed around the stacking space 41 at two angularly spaced apart positions and that respectively have targeting ends 52 protruding into the stacking space 41 to target each of the metal plate bodies 101 which moves past the targeting end while moving downward inside the stacking space 41. In this embodiment, the pre-fixing device 5 includes three laser welding machines 51 which are respectively disposed at three positions spaced apart from each other in an angular direction around the stacking space 41 and the front squeeze hole 71. Particularly, two of the laser welding machines 51 are respectively disposed at left and right sides of the stacking space 41, and the remaining laser welding machine 51 is disposed at a front side of the stacking space 41. In each of FIGS. 1 to 3, a direction perpendicular to the page of the drawing figure corresponds to a direction from the left side to the right side of the stacking space 41, and only one of the left and right laser welding machines 51 is shown (see the dash line which represents a targeting end 52 of the laser welding machine 51 (not illustrated) behind the stacking space 41 in FIG. 1 or 2); the front side of the stacking space 41 is shown near a left side of the page of the drawing figure. More specifically, each of the laser welding machines 51 has a targeting end 52 that penetrates through the first squeeze tube 7 to target the metal plate bodies 101 in the stacking space 41 and that is located at a targeting position lower than a top end of the stacking space 41 and higher than a bottom end of the stacking space 41 The targeting positions of the targeting ends 52 are spaced apart angularly around the stacking space 41 and are located at the same distance from the top or bottom end of the stacking space 41. The targeting end 52 of each laser welding machines 51 emits a laser beam, and when the metal plate bodies 101 are fed downwardly into the first squeeze hole 71 and stacking space 41, the laser welding machines 51 works synchronously to sequentially weld each of the metal plate bodies 101 with adjacent metal plate bodies to form the metal core 100. It is noted that in FIG. 3 only the weld beads produced by the front laser welding machine 51 on some metal plate bodies 101 are shown (see triangular marks at the front side). The two laser welding machines 51 at the left and right sides may be arranged to have the targeting ends 52 thereof being disposed at two angularly spaced apart targeting positions which are symmetrical with respect to an axis of the first stacking space 41 so that the metal plate bodies 101 are allowed to be welded at two symmetrical left and right positions and the stack of the metal plate bodies 101 are prevented from becoming distorted when being discharged from the stacking space 41. However, it should be noted that the number of laser welding machines 51 are not limited to the disclosed amounts, and that other quantities are possible.

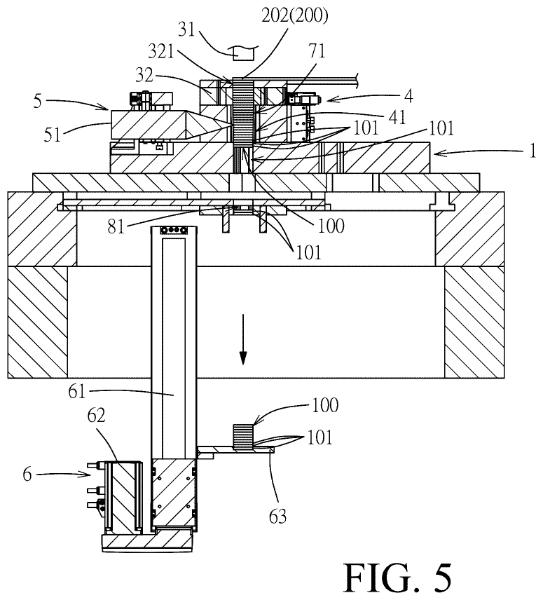

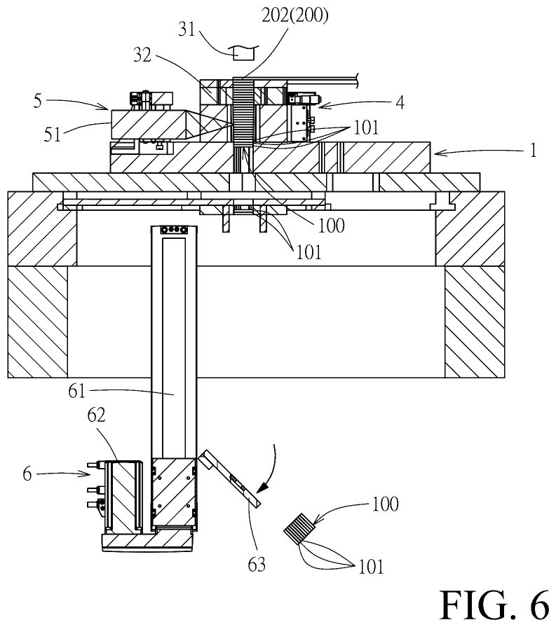

Referring to FIGS. 1, 3 and 6, the receiving device 6 is disposed below the base seat 1. The receiving device 6 includes an upstanding support 61, a pneumatic piston pump 62, and a carrier platform 63. The upstanding support 61 extends in a bottom-up direction to a level proximate to base seat 1. The pneumatic piston pump 62 is fitted to a bottom of the upstanding support 61, is connected with the carrier platform 63, and is controllable to drive the carrier platform 63 to move upward or downward relative to the upstanding support 61 (see FIGS. 1 and 6). Referring to FIG. 4, the carrier platform 63 is located below the stacking space 41, corresponds in position to said through hole 11 of the base seat 1, is adapted to receive the laminated core 100 descending downward from the stacking space 41, and is controllable to rotate downward or upward for discharging the laminated core 100. Referring to FIGS. 5 and 6, more specifically, the carrier platform 63 is movably connected to the upstanding support 61 and is controllable to rotate downward or upward about a connection point between the carrier platform 63 and the upstanding support 61 to change between a receiving position (see FIGS. 4 and 5) that is horizontal, and a discharge position (see FIG. 6) that is tilted and that allows said laminated core 100 to slide off the carrier platform 63 for discharge from the receiving device 6.

Referring to FIG. 4, in some embodiments, the manufacturing assembly includes a second squeeze tube 8 disposed below the base seat 1 and located between the base seat 1 and the carrier platform 63. The second squeeze tube 8 includes a second squeeze hole 81 that is aligned with the through hole 11 of the base seat 1 and corresponds in position with the carrier platform 63. The second squeeze hole 81 is adapted for the laminated core 100 to pass through in the downward direction, and has an upper opening having a diameter that is the same as a diameter of the upper opening of the first squeeze tube 71. In some embodiments, the second squeeze hole 81 of the second squeeze tube 8 progressively decreases in diameter from the upper opening in a downward direction. This may serve to restrict movement of the metal plate bodies 101 within the second squeeze hole 81 while they are not pushed downwardly. More specifically, when the laminated core 100 passes through the through hole 11 of the base seat 1 in the downward direction toward the carrier platform 63 of the receiving device 6, the second squeeze hole 81 may act to reduce the speed of the laminated core 100 during its descent, thereby avoiding collision between the laminated core 100 and the carrier platform 63 which may cause damage to either or both components.

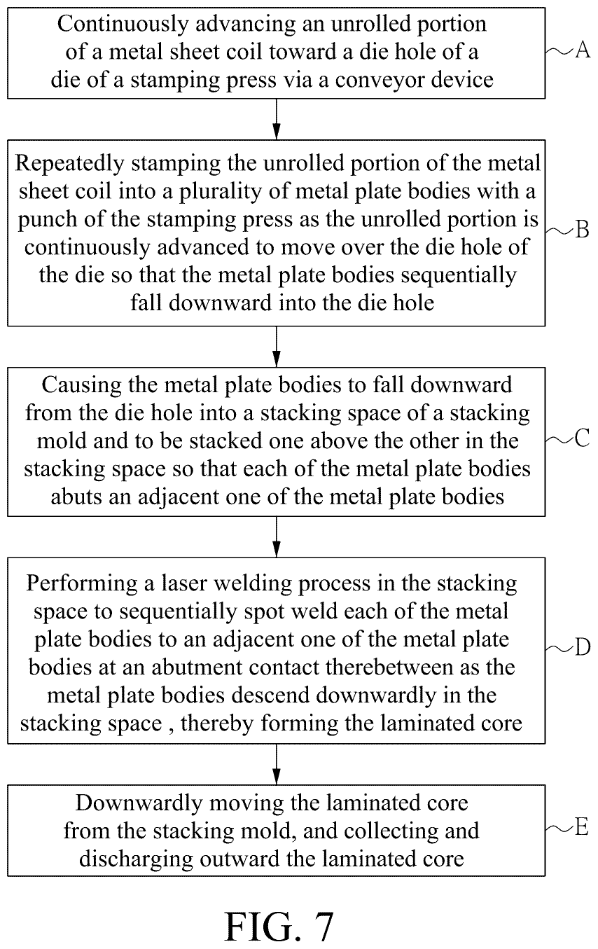

Referring to FIGS. 1 to 7, the embodiment of the manufacturing assembly is employed in a method of making laminated cores 100. The method of making laminated cores 100 includes the steps A) to E). In the step A) an unrolled portion 202 of a metal sheet coil 200 is continuously advanced towards a die hole 321 of a die of a stamping press 3 via a conveyor device 2. Afterwards, in the step B) the unrolled portion 202 of the metal sheet coil 200 is repeatedly stamped into a plurality of metal plate bodies 101 with a punch 31 of a stamping press 3 as the unrolled portion 202 is continuously advanced to move over the die hole 321 of the die 32 so that the metal plate bodies 101 sequentially fall downward into the die hole 321. More specifically, the punch 31 of the stamping press 3 reciprocates between an upward position and a downward position and stamps the unrolled portion 202 of the metal sheet coil 200 at the downward position. Each time the punch 31 stamps the unrolled portion 202 at the die hole 321, one metal plate body 101 is formed at the top end of the die hole 321 and falls downward into the die hole 321. When the metal plate bodies 101 fully fills the die hole 321, they are pushed downward to start to fall downward and outward from the die hole 321 by a new metal plate body 101 that is stamp-formed at the top end of the die hole 321.

Referring to FIGS. 3 and 4, next, in the step C), when the metal plate bodies start their outward falling movement from the die hole 321, the metal plate bodies 101 are caused to fall downward from the die hole 321 into a stacking space 41 of a stacking mold 4 and are caused to be stacked one above the other in the stacking space 41 so that each of the metal plate bodies 101 abuts an upper adjacent one of the metal plate bodies 101 and a lower adjacent one of the metal plate bodies 101.

Afterwards, in the step D) a laser welding process is performed in the stacking space to sequentially spot weld each of the metal plate bodies 101 to at least one of the upper and lower adjacent ones of the metal plate bodies 101 as the metal plate bodies 101 descend downwardly in the stacking space 41, thereby forming the laminated core 100. The laser welding process is performed in the stacking space 41 by using one or more than one laser welding machines 51. During laser welding, the positions of the laser welding machines are not changed. In some embodiments, the laser welding process is a cyclic process which includes a welding operation cycle for welding together a predetermined amount of the metal plate bodies 101 to produce one of the laminated cores 100, and a resting cycle to follow the welding operation cycle for temporarily stopping the welding operation. A total number of the welding operation cycles of the laser welding process corresponds to a total number of the laminated cores 100 produced by the laser welding process. During the welding operation cycle of the laser welding process, the metal plate bodies 101 moving downward in the stacking space 41 are sequentially laser targeted at least two laser targeting positions which are spaced apart angularly around the stacking space 41 and which are lower than a top end of the stacking space 41 and higher than a bottom end of the stacking space 41. Each of the metal plate bodies 101, while moving past the targeting position, is laser welded to the adjacent upper and lower adjacent ones of the metal plate bodies 101. During the resting operation cycle, the laser welding process stops temporarily to leave at least one of the metal plate bodies 101 (i.e., one or more than one metal plate bodies 101) to be un-welded and to thereby provide a weld-free isolation space between a predetermined amount of the metal plate bodies 101 which have yet to be welded and a predetermined amount of the metal plate bodies 101 which have been welded together previously. Referring to FIG. 4, in an exemplary embodiment of the method, two metal plate bodies 101 near the bottom of the stacking hole 41 are unwelded and are free of welds at upper and lower sides thereof so that there is a weld-free isolation space between a predetermined amount of the metal plate bodies 101 above the unwelded two metal plate bodies 101 and a predetermined amount of metal plate bodies 101 (not visible in FIG. 4) which have been welded together previously below the unwelded two metal plate bodies 101. A time period of the resting cycle may correspond to a time period required for at least one metal plate body 101 to be welded to the upper and lower adjacent ones of the metal plate bodies 101. By providing the weld-free isolation space to isolate the metal plate bodies 101 which have yet to be welded from the metal plate bodies 101 which have been welded previously, production errors in producing the laminated cores 100 may be minimized. As the metal plate bodies 101 descend downwardly in the stacking space 41 and form the laminated core 100, the laminated core will descend through the through hole 11.

Referring to FIGS. 4 to 6, afterwards, in the step E) the laminated core 100 is moved downwardly from the stacking mold 4, and then, the laminated core 100 is collected and discharged from the receiving device 6. More specifically, as shown in FIG. 4, the carrier platform 63 is driven by the piston pump 62 (see FIG. 5) to move upward until it reaches a highest position at the top of the upstanding support 61. At the highest position, the carrier platform 63 is in the receiving position that is horizontal and receives the laminated core 100 that descends through the through hole 11. Afterwards, as shown in FIG. 5, the carrier platform 63 carrying the laminated core 100 is driven to move downward to a lowest position distal from the base seat 1. Afterwards, referring to FIG. 6, the carrier platform 63 is controlled to tilt downward to the discharge position which allows the laminated core 100 to slide off the carrier platform 63 for discharge from the receiving device 6. After the laminated cores 100 are discharged, they may be transferred to an oven (not shown) to heat the laminated cores 100 so that the upper adhesive sections 101b and the lower adhesive sections 101c of the metal plate bodies 101 are fused and the metal plate bodies 101 are fusion bonded to each other. Each of the laminated cores 100 produced by the manufacturing assembly is a semi-finished product in which the metal plate bodies 101 are spot welded for prefixing a stack of the metal plate bodies 101 of each laminated core 100. The method of making the laminated core 100 according to the present disclosure allows the laminated core 100 to be preformed or prefixed by spot welding the metal plate bodies 101 in the stacking mold 4. Therefore, the stacking mold 4 need not be heated during formation of the metal plate bodies 101 into a stack. This allows the laminated core 100 to avoid possible deformation from prolonged heat exposure and increases service life of the stacking mold used for its manufacture. Additionally, the production quality of the laminated core 100 thus produced can be easily maintained.

In summary of the above, the manufacturing assembly for making the laminated core 100 and the method of making the laminated cores 100 according to the present disclosure uses at least two laser welding machines 51 to spot weld each of the metal plate bodies 101 to at least one adjacent metal plate body 101 at an abutment contact therebetween, thereby pre-fixing the laminated core 100. This may obviate the need to heat the stacking mold 4, and allows the manufacturing assembly to be simplified which reduces the rate of malfunctions. The manufacturing assembly according to the present disclosure may thus have a lower operating cost and have increased production yield rates.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A manufacturing assembly adapted for making a laminated core from a plurality of metal plate bodies, each of which has a plate body portion that has an upper adhesive section and a lower adhesive section respectively disposed on two opposite sides of the plate body portion, the manufacturing assembly comprising:
a stacking mold including a stacking space that extends through a top surface and a bottom surface of said stacking mold, said stacking space of said stacking mold being adapted for the metal plate bodies to be sequentially fed downwardly into said stacking space from said top surface of said stacking mold, so that the metal plate bodies are stacked one above the other, and so that the upper adhesive section of the plate body portion of each of the metal plate bodies abuts a lower adhesive section of the plate body portion of an adjacent one of the metal plate bodies;
a pre-fixing device including at least two laser welding machines that are disposed around said stacking space at two angularly spaced apart positions and that respectively have targeting ends, said targeting ends being spaced apart angularly around said stacking space and protruding into said stacking space to target each of the metal plate bodies which moves past said targeting end while moving downward inside the stacking space, said at least two laser welding machines sequentially welding each of the metal plate bodies to at least one of an upper adjacent one of the metal plate bodies and a lower adjacent one of the metal plate bodies to form the laminated core; and
a receiving device including a carrier platform that is located below said stacking space, that is adapted to receive the laminated core descending downward from said stacking space, and that is controllable to flip and discharge outward the laminated core.

2. The manufacturing assembly as claimed in claim 1, further comprising a conveyor device, and a stamping press that is located downstream of the conveyor device and above said stacking mold, said conveyor device being adapted to continuously convey an unrolled portion of a metal sheet coil;
wherein said stamping press includes a punch and a die that is located below said punch, that has a die hole extending through a top surface and a bottom surface of said die, and aligned with said punch and said stacking space; and
wherein said top surface of said die is located at a downstream side of said conveyor device for holding the unrolled portion of the metal sheet coil that is conveyed by said conveyor device, said punch being located above said top surface of said die and adapted to repeatedly stamp the unrolled portion of the metal sheet coil into the metal plate bodies as the unrolled portion is advanced by said conveyor device to move over said die hole, so that the metal plate bodies fall into said die hole and are then fed to said stacking space.

3. The manufacturing assembly as claimed in claim 2, further comprising a first squeeze tube that is disposed in said stacking space, and that includes a first squeeze hole aligned with said die hole, adapted for receiving said metal plate bodies that are stacked one above the other, and having an upper opening with a diameter that is not greater than that of said die hole;
wherein each of said at least two laser welding machines has said targeting end that penetrates through said first squeeze tube to target the metal plate bodies in said stacking space.

4. The manufacturing assembly as claimed in claim 3, wherein said first squeeze hole progressively decreases in diameter from said upper opening in a downward direction.

5. The manufacturing assembly as claimed in claim 3, further comprising:
a base seat disposed below said stacking mold, and including a through hole that extends through a top surface and a bottom surface of said base seat, and that is adapted for the laminated core to pass through in a downward direction; and
a second squeeze tube disposed below said base seat, including a second squeeze hole that is adapted for the laminated core to pass through in the downward direction, that is aligned with said through hole, and that has an upper opening having a diameter that is the same as a diameter of said upper opening of said first squeeze tube.

6. The manufacturing assembly as claimed in claim 1, wherein said pre-fixing device includes three laser welding machines, two of which are respectively disposed at left and right sides of said stacking space, and the remaining one of which is disposed at a front side of said stacking space.

7. The manufacturing assembly as claimed in claim 1, wherein:
said receiving device further includes an upstanding support;
said carrier platform is movably connected to said upstanding support, and being controllable to rotate about a connection point between said carrier platform and said upstanding support to change between a receiving position that is horizontal, and a discharge position that allows said laminated core to discharge from said receiving device.

8. The manufacturing assembly as claimed in claim 7, wherein said receiving device further includes a pneumatic piston pump that is connected with said carrier platform, and that is controllable to drive said carrier platform to move upward or downward relative to said upstanding support.

9. The manufacturing assembly as claimed in claim 1, wherein each of said at least two laser welding machines is configured to operate a cyclic process which includes a welding operation cycle for welding together a predetermined amount of the metal plate bodies to produce one of the laminated cores, and a resting cycle to follow said welding operation cycle for temporarily stopping the welding of the metal plate bodies.

10. A method of making laminated cores comprising steps of:
A) continuously advancing an unrolled portion of a metal sheet coil toward a die hole of a die of a stamping press via a conveyor device;
B) repeatedly stamping the unrolled portion of the metal sheet coil into a plurality of metal plate bodies with a punch of the stamping press as the unrolled portion is continuously advanced to move over the die hole of the die so that the metal plate bodies sequentially fall downward into the die hole;
C) causing the metal plate bodies to fall downward from the die hole into a stacking space of a stacking mold and to be stacked one above the other in the stacking space so that each of the metal plate bodies abuts an upper adjacent one of the metal plate bodies and a lower adjacent one of the metal plate bodies;
D) performing a laser welding process in the stacking space to sequentially spot weld each of the metal plate bodies to at least one of the upper and lower adjacent ones of the metal plate bodies as the metal plate bodies descend downwardly in the stacking space, thereby forming the laminated core; and
E) downwardly moving the laminated core from the stacking mold, and collecting and discharging the laminated core.

11. The method as claimed in claim 10, wherein:
the laser welding process is a cyclic process which includes a welding operation cycle for welding together a predetermined amount of the metal plate bodies to produce one of the laminated cores, and a resting cycle following the welding operation cycle for temporarily stopping the welding of the metal plate bodies;
during the welding operation cycle, the metal plate bodies moving downward in the stacking space are sequentially laser targeted until the predetermined amount of the metal plate bodies are welded together;
during the resting cycle, the operation of the laser welding process stops temporarily to leave at least one of the metal plate bodies to be un-welded and to thereby provide a weld-free isolation space between a predetermined amount of the metal plate bodies which have yet to be welded and a predetermined amount of the metal plate bodies which have been welded previously.

12. The method as claimed in claim 11, wherein, during the welding operation cycle, the metal plate bodies sequentially move past at least two laser targeting positions which is lower than a top end of the stacking space and higher than a bottom end of the stacking space, and which are spaced apart angularly around the stacking space and each of the metal plate bodies, while moving past the at least two laser targeting positions, and is laser spot welded to the at least one of the upper and lower adjacent ones of the metal plate bodies.
